(19) United States
(12) Patent Application Publication
(10) Pub. No.: US 2010/0271201 A1
(43) Pub. Date: Oct. 28, 2010

(54) WIRELESS POSITIONING DEVICE FOR GROUP MANAGEMENT

(76) Inventor: Teng An-Tsun, Jhubei City (TW)

Correspondence Address: Muncy, Geissler, Olds & Lowe, PLLC, 4000 Legato Road, Suite 310, FAIRFAX, VA, 22033, US

(21) Appl. No.: 12/429,831

(22) Filed: Apr. 24, 2009

(51) Int. Cl. G08B 1/08

(52) U.S. Cl. 340/539.13

(57) ABSTRACT

A wireless positioning device for group management is installed to a plurality of user's devices in a group, and the device includes: a central processing unit (CPU); a global positioning system (GPS) module; a short-distance wireless communication module; a memory; and a display device. In addition to a positioning function, the device can transmit and receive information with the user's devices in the group without requiring an additional mobile communication system.

### FIELD OF THE INVENTION

The present invention relates to a wireless positioning device, and more particularly to a wireless positioning device provided for group management through a wireless network.

### BACKGROUND OF THE INVENTION

Nowadays, people pay more attentions to leisure and sport activities such as mountain climbing or bicycling in our busy industrial and commercial society, and thus sports equipments of various sports bloom. In an exercise, the traveling speed of each person varies, such that the original gathered team becomes scattered after the team travels for a period of time, and the span of the traveling team becomes longer, thus causing a group management problem when the group is traveling. If any team member has emergency or accident, responses and remedial actions cannot be taken in time. Obviously, group management is an indispensable issue of a traveling group.

At present, a common global positioning system (GPS) available in the market can use a constellation of satellites high above the earth to determine a precise position of a satellite signal receiver on the earth's surface. However, the conventional GPS provides the position of a user only and requires another mobile communication system such as GSM and GPRS to obtain the positions of others for managing the traveling group or transmitting information among the positioning devices of the group. As we all know that the mobile communication system must be connected to a base station for its communications which consumes a large quantity of power and also becomes a major unfavorable factor to outdoor applications. Furthermore, the mobile communication system generally has a weak signal reception, or cannot receive signals in the mountains or remote areas, and incurs a high cost.

### SUMMARY OF THE INVENTION

Therefore, it is a primary objective of the present invention to provide a wireless positioning device for group management, wherein the wireless positioning device is installed in a group of a plurality of devices. In addition to the positioning function, this invention also allows users to transmit and receive information with other user's devices in the group without requiring an additional mobile communication system.

The present invention primarily uses a short-distance wireless communication method to communicate with the user devices in the group, and such short-distance wireless communication can be a ZigBee wireless communication module capable of forming a wireless network for the user's devices within a specific range and communicating with any of the user's devices timely, and achieving the effect of low power consumption. With the invention, information transmissions are no longer limited by the base station.

To achieve the foregoing objective, the present invention provides a wireless positioning device for group management, and the device is installed to a plurality of devices in a group, and comprises: a central processing unit (CPU); a global positioning system (GPS) module, electrically coupled to the CPU, for receiving a satellite signal to perform a coordinates positioning; a short-distance wireless communication module, electrically coupled to the CPU, for transmitting and receiving information with other user's devices in the group within a wireless network; a memory, electrically coupled to the CPU, for storing coordinates information transmitted from other user's devices and storing a position estimation program for operating the CPU to estimate a distance from other user's devices; and a display device, electrically coupled to the CPU, for displaying the information of the distance from each of the other user's devices.

In a preferred embodiment of the present invention, the invention is applied to a bicycling activity, a mountain climbing activity or any other group activities.

In a preferred embodiment of the present invention, the short-distance wireless communication module is a ZigBee wireless communication module.

In a preferred embodiment of the present invention, the memory further stores an instruction transmission program for transmitting a specific instruction to other user's devices in the group through the short-distance wireless communication module.

In a preferred embodiment of the present invention, the memory further stores an out-of-range alarm program for monitoring a distance of the user's device from other user devices in the group, such that if the distance exceeds a safety distance, then a warning signal will be generated. In addition, the wireless positioning device further includes a warning unit electrically coupled to the CPU for responding to the warning signal.

In a preferred embodiment of the present invention, the wireless positioning device further includes a tilt sensing unit electrically coupled to the CPU for transmitting an emergency signal to other user's devices in the group through the short-distance wireless communication module if the tilting condition exceeds a safety value.

In a preferred embodiment of the present invention, the central processing unit and the GPS module are integrated into an integrated unit, and the integrated unit is electrically and individually coupled to the short-distance wireless communication module, the memory and the display device.

In the present invention, the wireless positioning device for group management can timely transmit and receive information with other user's devices in the same group, and the invention has the advantages including low power consumption and low cost. Users can use this device for managing and controlling a travelling group effectively and providing appropriate assistance or remedial actions for emergencies or accidents timely.

### BRIEF DESCRIPTION OF THE DRAWINGS

FIG. 1 is a functional block diagram of a wireless positioning device in accordance with a preferred embodiment of the present invention; and

FIG. 2 is a functional block diagram of a wireless positioning device in accordance with another preferred embodiment of the present invention; and

FIG. 3 is a schematic view of using a wireless positioning device in accordance with a preferred embodiment of the present invention.

### DESCRIPTION OF THE PREFERRED EMBODIMENT

Other features and advantages of the present invention will become apparent in the following detailed description of the preferred embodiments with reference to the accompanying drawings.

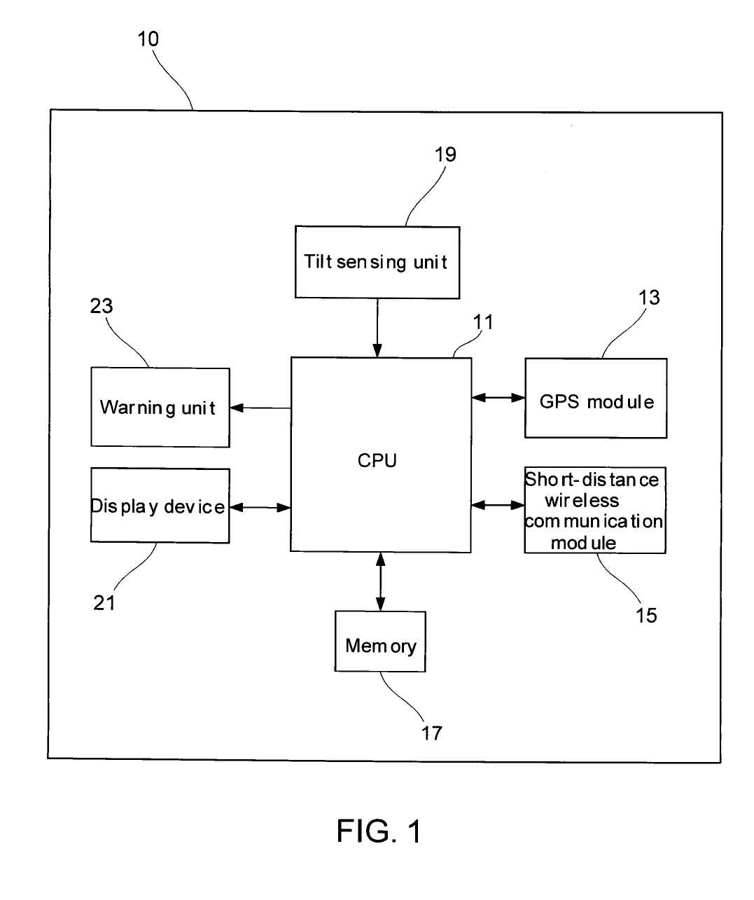

With reference to FIG. 1 for a functional block diagram of a wireless positioning device 10 for group management in accordance with a preferred embodiment of the present invention, the wireless positioning device 10 is installed to a plurality of user's devices of a group and comprises: a CPU 11, a GPS module 13, a short-distance wireless communication module 15, a memory 17, a tilt sensing unit 19, a display device 21 and a warning unit 23.

The wireless positioning device 10 can be a handheld user device whose components are described as follows.

The CPU 11 serves as a main control center and estimates a distance based on the inputted coordinates information.

The GPS module 13 is electrically coupled to the CPU 11 for receiving a satellite signal high above the earth's surface, positioning the wireless positioning device 10, and outputting coordinates information of the wireless positioning device 10 to the CPU 11.

The short-distance wireless communication module 15 is electrically coupled to the CPU 11 for establishing the wireless network with the other user's devices in the group and executing one-to-one, one-to-many or many-to-many node communications. In other words, information is transmitted and received with other user devices within the wireless network, wherein the short-distance wireless communication module 15 of this embodiment is a ZigBee wireless communication module having a low power consumption feature.

The memory 17 is electrically coupled to the CPU 11 for storing coordinates information transmitted from other user's devices, and storing a position estimation program for operating the CPU 11 to estimate a distance of the user's device from each of the other user's devices.

The memory 17 stores an instruction transmission program provided for the wireless positioning device 10 to transmit a specific instruction to other user's devices in the group through the short-distance wireless communication module 15. For example, a user's device in the group can be a leader who issues an instruction to the group to move on, stopping or move backward, so that the other user's devices in the group can know about the information of each instruction via the display device 21. In addition, each user's device can transmit information such as textual information of the instruction to other user's devices through the wireless positioning device 10.

To maintain the desired span of the entire traveling group, the memory 17 further stores an out-of-range alarm program for monitoring the distance of the user's device from other user's devices in the group, such that if the distance exceeds a safety distance, a warning signal will be generated and transmitted through the short-distance wireless communication module 15. After any of the other user's devices in the group receives the warning signal, such user's device is electrically coupled to the warning unit 23 of the CPU 11 to respond to the warning signal and allow other users to know about an emergency situation or accident of a certain particular user in the group as well as the exact position of the accidence according to the distance information.

The tilt sensing unit 19 is electrically coupled to the CPU 11, such that if the tilting condition exceeds a safety value in a fall or topple accident, the short-distance wireless communication module 15 will issue an emergency signal to other user's devices in the group. The tilt sensing unit 19 can be any tilt sensing device such as a mercury sensor whose detection principle resides on using flowing mercury spheres with high surface tension to connect conductive wires at both ends inside the mercury sensor for controlling ON/OFF states of the mercury sensor. If a user has an emergency or accident such as a fall or topple during the traveling, the tilt sensing unit 19 will be able to detect the situation and issue the emergency signal immediately.

The display device 21 is electrically coupled to the CPU 11 for displaying the information of a distance of the user's device from other user's devices, so that a user can control the distance from each other user device of the traveling group. As mentioned previously, the display device 21 can display instruction information and emergency signals, wherein the display device 21 can be a touch screen.

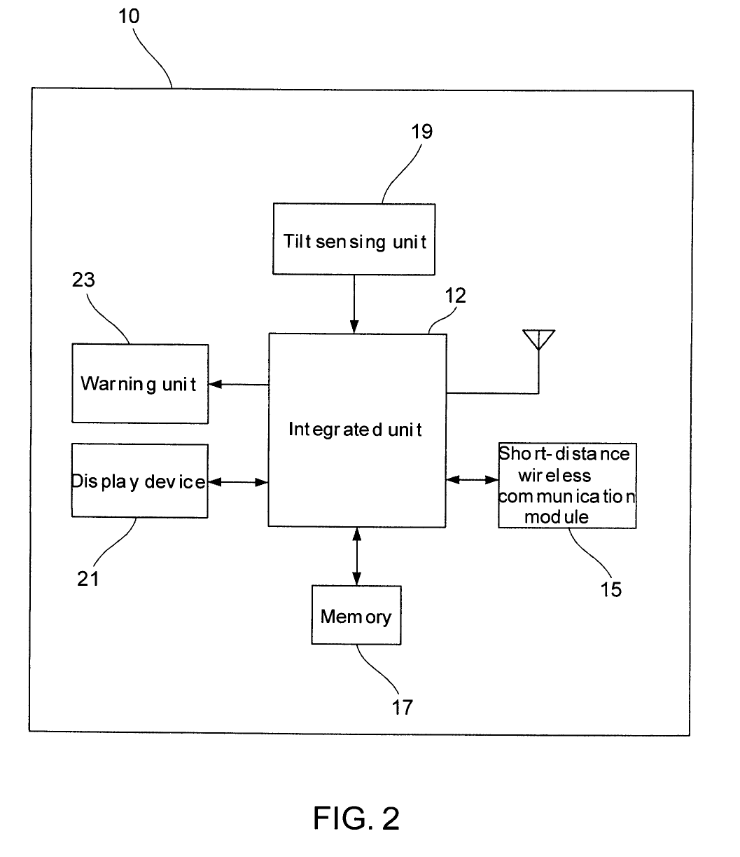

With reference to FIG. 2 for a functional block diagram of a wireless positioning device in accordance with another preferred embodiment of the present invention, the central processing unit 11 is integrated with the GPS module 13 to form an integrated unit 12, and the integrated unit 12 will execute the original functions of the central processing unit 11 and the GPS module 13, and the integrated unit is electrically and individually coupled to the short-distance wireless communication module 15, the memory 17, the tilt sensing unit 19, the display device 21 and the warning unit 23.

In the foregoing preferred embodiments, the tilt sensing unit 19 and the warning unit 23 are added. In a preferred embodiments, the original existing central processing unit 11, the GPS module 13, the short-distance wireless communication module 15, the memory 17 and the display device 21 can achieve the functions of transmitting and receiving information from each other among the user devices in the group. In another preferred embodiments, the integrated unit 12, the short-distance wireless communication module 15, the memory 17 and the display device 21 can achieve the functions of transmitting and receiving information from each other among the user devices in the group.

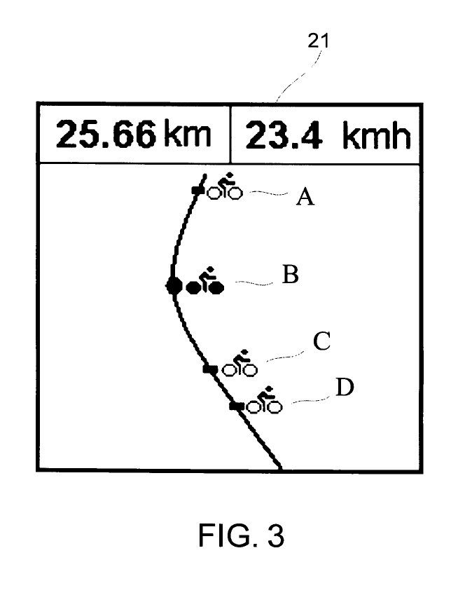

With reference to FIG. 3 for a schematic view of using a wireless positioning device in accordance with a preferred embodiment of the present invention, a user B, who is also a leader of a group, is riding a bicycle, and users A, C, D are other users in the group. In FIG. 2, the distance of the user B from the destination is equal to 25.66 km, and the current speed is equal to 23.4 km/h. Since each user is equipped with a wireless positioning device 10 of the invention, therefore coordinates information of each user A, C, D can be obtained from the GPS module 13, and the short-distance wireless communication module 15 transmits such coordinates information to the leader B. The distance between the leader B and other users can be displayed on a screen of the display device 21 according to the computed distance information.

On the other hand, if a user D goes beyond a predetermined safety range, the leader B will be able to obtain such information from the display device 21 and the leader B can issue a stop instruction to other users A, C to wait for the user D to enter into the safety range. In addition, if there is any emergency situation such as another user A, C or D sends out an instruction or the tilt sensing unit 19 detects a fall or a topple, the leader B can know about the situation and take necessary emergency actions accordingly.

In summation of the description above, the present invention uses the GPS module and the short-distance wireless communication module to obtain a precise position, and transmit and receive information in a group. As long as the user devices of the group are within the wireless network, the effect of group management can be achieved even in mountains or remote areas without any transmission problem in the group.

The invention can be applied to a group of people who attend a leisure activity such as riding a bicycle, shopping, climbing a mountain, playing in a playground or in an any occasion that one may wander away from the group easily. Particularly for the bicycling or mountain climbing activity, the invention is very effective, and one can know one's position as well as others' positions for an effective management.

While the invention has been described by means of specific embodiments, numerous modifications and variations could be made thereto by those skilled in the art without departing from the scope and spirit of the invention set forth in the claims.

What is claimed is:

1. A wireless positioning device for group management, installed to a plurality of user's devices of a group, and comprising:
a central processing unit (CPU);
a global positioning system (GPS) module, electrically coupled to the CPU, for receiving a satellite signal to perform a coordinates positioning;
a short-distance wireless communication module, electrically coupled to the CPU, for transmitting and receiving information with other user's devices in the group within a wireless network;
a memory, electrically coupled to the CPU, for storing coordinates information transmitted from the other user devices, and storing a position estimation program for operating the CPU to estimate a distance between the other user's devices; and
a display device, electrically coupled to the CPU, for displaying the distance information with each of the other user's devices.

2. The wireless positioning device for group management as recited in claim 1, being applied to a bicycling activity or a mountain climbing activity.

3. The wireless positioning device for group management as recited in claim 1, wherein the short-distance wireless communication module is a ZigBee wireless communication module.

4. The wireless positioning device for group management as recited in claim 1, wherein the memory stores an instruction transmission program for transmitting a specific instruction to the other user's devices in the group through the short-distance wireless communication module.

5. The wireless positioning device for group management as recited in claim 1 wherein the memory stores an out-of-range alarm program for monitoring a distance of the user's device from the other user's devices in the group, and generating a warning signal if the distance exceeds a safety distance.

6. The wireless positioning device for group management as recited in claim 5, further comprising a warning unit electrically coupled to the CPU for responding to the warning signal.

7. The wireless positioning device for group management as recited in claim 1, further comprising a tilt sensing unit electrically coupled to the CPU for transmitting an emergency signal to the other user's devices in the group through the short-distance wireless communication module if a tilting condition exceeds a safety value.

8. The wireless positioning device for group management as recited in claim 1, wherein the central processing unit and the GPS module are integrated into an integrated unit, and the integrated unit is electrically and individually coupled to the short-distance wireless communication module, the memory and the display device.
